(19) United States
(12) Patent Application Publication
(10) Pub. No.: US 2025/0190605 A1
(43) Pub. Date: Jun. 12, 2025

(54) COMPUTER-IMPLEMENTED METHOD AND SYSTEM FOR STORING VERIFIABLE DATA

(71) Applicant: AIO Technology Reserve Pte. Ltd., THE CENTRAL SINGAPORE (SG)

(72) Inventors: Chu George Kai, Taipei City (TW); Feng-Chia Chang, Taipei City (TW); An-Kuo Li, Taipei City (TW)

(21) Appl. No.: 18/599,291

(22) Filed: Mar. 8, 2024

Related U.S. Application Data
(60) Provisional application No. 63/607,129, filed on Dec. 7, 2023.

(51) Int. Cl. G06F 21/62

(52) U.S. Cl. CPC G06F 21/6218

(57) ABSTRACT

A computer-implemented method and system for storing verifiable data. The method comprises: generating a metadata object; generating at least one claim object; generating a proof object; generating multiple identifiers, wherein each of the identifiers corresponds to the metadata object, the at least one claim object and the proof object, respectively; and generating a Merkle DAG based on the multiple identifiers, the metadata object, the at least one claim object, and the proof object, wherein the Merkle DAG is constructed by nodes which are created based on the multiple identifiers.

### RELATED APPLICATIONS

The present application claims the priority of U.S. Provisional Patent Application No. 63/607,129, the disclosure of which is hereby incorporated by reference herein in its entirety.

### BACKGROUND OF THE INVENTION

### 1. Field of the Invention

The present inventive concept generally relates to a computer-implemented method and system for storing verifiable data.

### 2. Description of the Related Art

In general, in order to assetize data or use the blockchain to store data, we must ensure the integrity, authenticity and verifiability of the data. Therefore, a data format called VC, Verifiable Credential, is used in the prior art and the VC is stored in a distributed system. The distributed system may be, for example, IPFS or the like, and the distributed system does not provide built-in privacy function or encryption function. In addition, the data content stored in the distributed system is usually public, and verifiers can review the data content to ensure its authenticity and verifiability.

However, since other participants other than the verifiers can also view the public data content, a privacy issue exists in the technical solution in the prior art. Providers of the data content do not want all data content to be viewed by everyone. Therefore, how to provide a computer-implemented method and system for storing verifiable data that can take into account the privacy, integrity, authenticity and verifiability has become an urgent problem to be solved in the industry.

### SUMMARY OF THE INVENTION

In light of solving the foregoing problems of the prior art, the present inventive concept provides a computer-implemented method and system for storing verifiable data that can take into account the privacy, integrity, authenticity and verifiability.

In order to solve the aforementioned problems, the computer-implemented method for storing verifiable data of the present inventive concept comprising: generating a metadata object; generating at least one claim object; generating a proof object; generating multiple identifiers, wherein each of the identifiers corresponds to the metadata object, the at least one claim object and the proof object, respectively; and generating a Merkle DAG based on the multiple identifiers, the metadata object, the at least one claim object, and the proof object, wherein the Merkle DAG is constructed by nodes which are created based on the multiple identifiers.

In an embodiment, the method further comprises: transmitting the metadata object, the at least one claim object and the proof object to a first storage system, and storing the metadata object, the at least one claim object and the proof object via the first storage system.

In an embodiment, the first storage system is a storage system having authority control over the objects.

In an embodiment, the method further comprises: transmitting the Merkle DAG to a second storage system, and storing the Merkle DAG via the second storage system.

In an embodiment, the second storage system is a Ledger database.

In an embodiment, each of the multiple identifiers has hash information, respectively.

The present inventive concept further provides a system for storing verifiable data, the system comprises a processor; and a computer-readable medium storing program instructions that when executed by the processor cause the processor to: generate a metadata object; generate at least one claim object; generate a proof object; generate multiple identifiers, wherein each of the identifiers corresponds to the metadata object, the at least one claim object and the proof object, respectively; and generate a Merkle DAG based on the multiple identifiers, the metadata object, the at least one claim object, and the proof object, wherein the Merkle DAG is constructed by nodes which are created based on the multiple identifiers.

In an embodiment, the program instructions are executed by the processor to: transmit the metadata object, the at least one claim object and the proof object to a first storage system, and store the metadata object, the at least one claim object and the proof object via the first storage system.

In an embodiment, the first storage system is a storage system having authority control over the objects.

In an embodiment, the program instructions are executed by the processor to: transmit the Merkle DAG to a second storage system, and store the Merkle DAG via the second storage system.

In an embodiment, the second storage system is a Ledger database.

In an embodiment, each of the multiple identifiers has hash information, respectively.

Compared to the prior art, the data content generated by the computer-implemented method for storing verifiable data of the present inventive concept comprises a metadata object, at least one claim object, and a proof object. The method further comprises generating a Merkle DAG based on the multiple identifiers, the metadata object, the at least one claim object, and the proof object, wherein the Merkle DAG is constructed by nodes which are created based on the multiple identifiers. Once the content of the metadata object, the at least one claim object, or the proof object has been modified, the identifier corresponding to the modified content will not be the same as the identifier corresponding to the previous content. Therefore, we can ensure the integrity, authenticity and verifiability of the data content via the Merkle DAG. On the other hand, the data content is stored in the at least one claim object, and a provider of the data content may have options to disclose all or part of the claim object(s). The provider of the data content can ensure the privacy via selective disclosure. Thereby, the computer-implemented method and system for storing verifiable data of the present inventive concept can take into account the privacy, integrity, authenticity and verifiability.

### BRIEF DESCRIPTION OF THE DRAWINGS

FIG. 1 illustrates a flowchart of the computer-implemented method for storing verifiable data according to a first embodiment of the present inventive concept.

FIG. 2 illustrates a data content generated by the computer-implemented method for storing verifiable data according to a second embodiment of the present inventive concept.

FIG. 3 illustrates a Merkle DAG generated by the computer-implemented method for storing verifiable data according to a third embodiment of the present inventive concept.

FIG. 4 illustrates a flowchart of the computer-implemented method for storing verifiable data according to a fourth embodiment of the present inventive concept.

FIG. 5 illustrates a schematic view of the computer-implemented system for storing verifiable data according to a fifth embodiment of the present inventive concept.

### DETAILED DESCRIPTION

The present inventive concept is described by the following specific embodiments. Those with ordinary skills in the arts can readily understand other advantages and functions of the present inventive concept after reading the disclosure of this specification. Any changes or adjustments made to their relative relationships, without modifying the substantial technical contents, are also to be construed as within the range implementable by the present inventive concept.

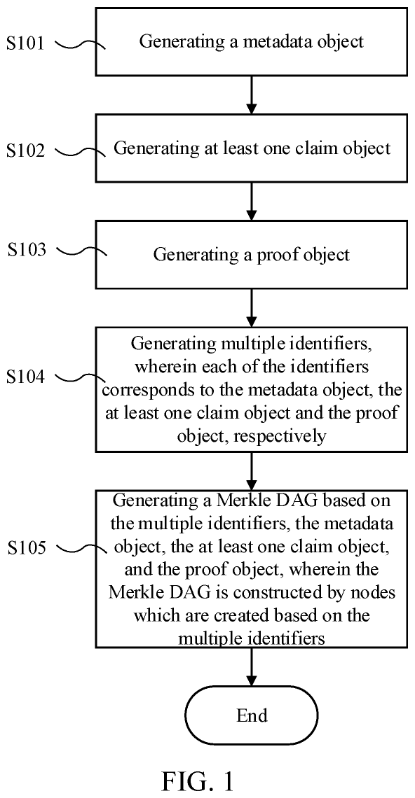

Please refer to FIG. 1. FIG. 1 illustrates a flowchart of the computer-implemented method for storing verifiable data according to a first embodiment of the present inventive concept. The computer-implemented method for storing verifiable data of the present inventive concept comprises the following steps:

S101. Generating a metadata object.

S102. Generating at least one claim object.

S103. Generating a proof object.

S104. Generating multiple identifiers, wherein each of the identifiers corresponds to the metadata object, the at least one claim object and the proof object, respectively.

S105. Generating a Merkle DAG based on the multiple identifiers, the metadata object, the at least one claim object, and the proof object, wherein the Merkle DAG is constructed by nodes which are created based on the multiple identifiers.

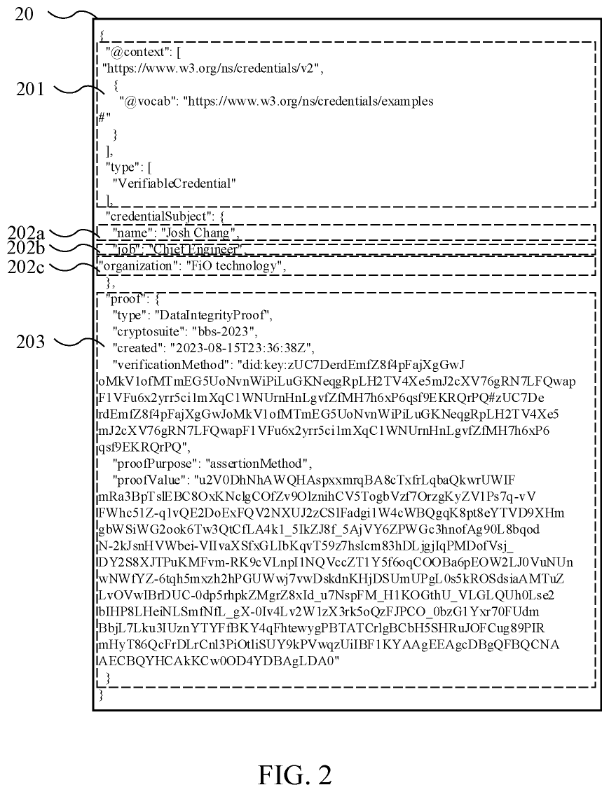

Please refer to FIG. 2. FIG. 2 illustrates a data content generated by the computer-implemented method for storing verifiable data according to a second embodiment of the present inventive concept. As shown in FIG. 2, a data content 20 generated through steps S101-S103 comprises a metadata object 201, claim objects 202a, 202b, 202c and a proof object 203. In an embodiment, the claim objects 202a-202c of the data content 20 may be the primary data provided by a provider. For example, the primary data may be the original data for generating carbon assets, diplomas, or other data that needs to be verified. In an embodiment, the proof object 203 comprises a signature for the entire data content 20. When the data content is being verified, an independent signature will be dynamically generated for any of the claim object 202a-202c based on the proof object 203. The signature may be used to verify the integrity and authenticity of the data content 20. All other keys in the data content 20 may be sorted as the metadata object 201.

In another embodiment, the claim objects 202a-202c of the data content 20 may be a metadata object, a claim object and a proof object of other data content.

In step S104, multiple identifiers are generated, wherein each of the identifiers corresponds to the metadata object, the at least one claim object and the proof object, respectively. More specifically, once the content of the metadata object, the at least one claim object, or the proof object has been modified, the identifier corresponding to the modified content will not be the same as the identifier corresponding to the previous content. Therefore, we care able to ensure the integrity of the data content 20 via the identifiers.

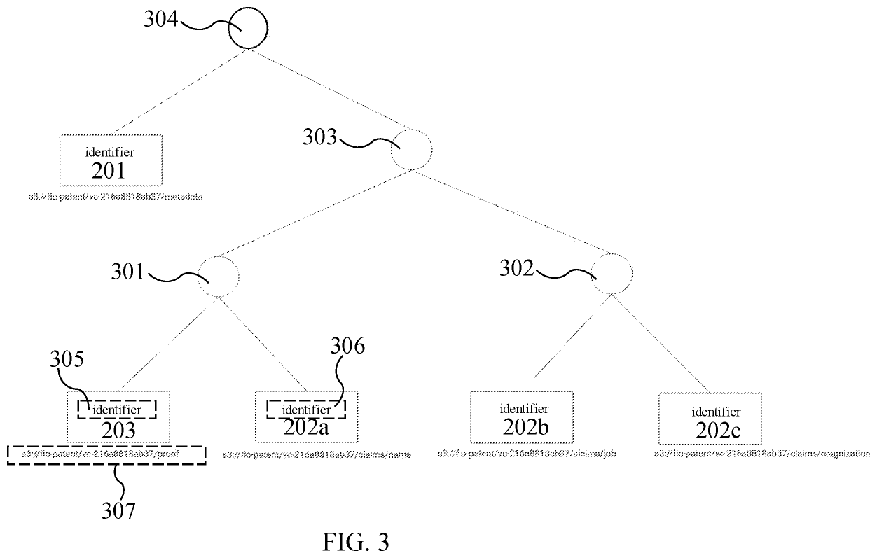

Please refer to FIG. 3. FIG. 3 illustrates a Merkle DAG generated by the computer-implemented method for storing verifiable data according to a third embodiment of the present inventive concept. The Merkle DAG comprises the contents of the metadata object 201, claim objects 202a, 202b, 202c and the proof object 203. The Merkle DAG further comprises nodes 301, 302, 303, and 304 created based on the identifiers. For example, the node 301 is created based on the identifier corresponding to the proof object 203 and the identifier corresponding to the claim object 202a. The node 302 is created based on the identifier corresponding to the claim object 202b and the identifier corresponding to the claim object 202c. The node 303 is created based on the node 301 and the node 302. The node 304 is created based on the node 303 and the identifier corresponding to the metadata object 201. In other words, once the content stored in the Merkle DAG has been modified, it is possible to find out which content has been modified by nodes 301-304.

In an embodiment, objects whose content changes more frequently may be placed at the bottom layer of the Merkle DAG, which can reduce computation during the update.

In an embodiment, the identifiers corresponding to the metadata object 201, claim objects 202a, 202b, 202c and the proof object 203 have hash information, respectively. In the embodiment of FIG. 3, the node 301 is composed of the identifier 305 with hash information and the identifier 306 with hash information.

In an embodiment, the node 304 is referred to as a root node and may be used to search the corresponding Merkle DAG. In addition, the node 304 may also be used to confirm whether any content of the corresponding Merkle DAG has been modified.

In an embodiment, the metadata object 201, claim objects 202a, 202b, 202c and the proof object 203 each generate a distinct identifier, forming the basis for the Merkle DAG. The Merkle DAG of FIG. 3 is structured through nodes, derived from these generated identifiers.

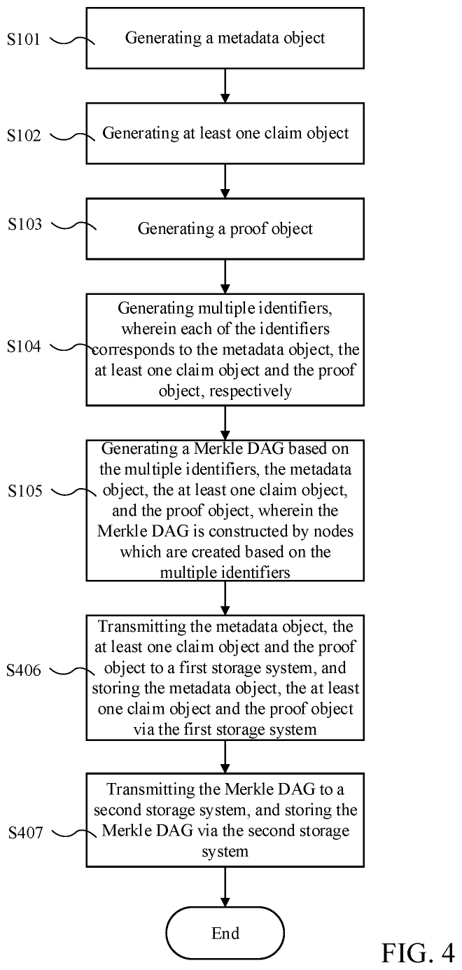

Please refer to FIG. 4. FIG. 4 illustrates a flowchart of the computer-implemented method for storing verifiable data according to a fourth embodiment of the present inventive concept. In an embodiment, the computer-implemented method for storing verifiable data of the present inventive concept further comprises:

S406. Transmitting the metadata object, the at least one claim object and the proof object to a first storage system, and storing the metadata object, the at least one claim object and the proof object via the first storage system.

S407. Transmitting the Merkle DAG to a second storage system, and storing the Merkle DAG via the second storage system.

In an embodiment, the first storage system is a storage system having an authority control over the objects, such as AWS S3, but not limited thereto. In another embodiment, any other available storage system with or without an authority control over the objects may also be used as needed.

In an embodiment, the second storage system is a Ledger database. Ledger database is an immutable storage system, such as AWS QLDB, but not limited thereto.

In an embodiment, each of the multiple identifiers has hash information, respectively.

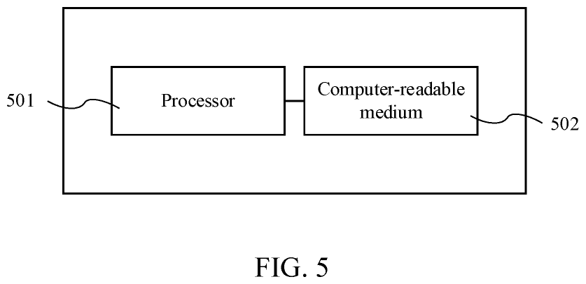

Please refer to FIG. 5. FIG. 5 illustrates a schematic view of the computer-implemented system for storing verifiable data according to a fifth embodiment of the present inventive concept. The system for storing verifiable data of the present inventive concept comprises a processor 501 and a computer-readable medium 502 storing program instructions.

When the program instructions are executed by the processor 501, the processor 501 executes to: generate a metadata object; generate at least one claim object; generate a proof object; generate multiple identifiers, wherein each of the identifiers corresponds to the metadata object, the at least one claim object and the proof object, respectively; and generate a Merkle DAG based on the multiple identifiers, the metadata object, the at least one claim object, and the proof object, wherein the Merkle DAG is constructed by nodes which are created based on the multiple identifiers.

In an embodiment, when the program instructions are executed by the processor 501, the processor 501 executes the steps in the above-mentioned embodiments of the present inventive concept, such as S101-S105, etc.

In an embodiment, the computer-readable medium 502 may be, for example, RAM, a hard disk or a USB flash drive, and so on, but not limited thereto.

In an embodiment, when the program instructions are executed by the processor, to the processor executes to: transmit the metadata object, the at least one claim object and the proof object to a first storage system, and store the metadata object, the at least one claim object and the proof object via the first storage system.

In an embodiment, the first storage system is a storage system having an authority control over the objects.

In an embodiment, when the program instructions are executed by the processor, the processor executes to: transmit the Merkle DAG to a second storage system, and store the Merkle DAG via the second storage system.

In an embodiment, the second storage system is a Ledger database.

In an embodiment, each of the multiple identifiers has hash information, respectively.

In summary, the data content generated by the computer-implemented method for storing verifiable data of the present inventive concept comprises a metadata object, at least one claim object, and a proof object. The method further comprises generating a Merkle DAG based on the multiple identifiers, the metadata object, the at least one claim object, and the proof object, wherein the Merkle DAG is constructed by nodes which are created based on the multiple identifiers. Once the content of the metadata object, the at least one claim object, or the proof object has been modified, the identifier corresponding to the modified content will not be the same as the identifier corresponding to the previous content. Thereby, we are able to ensure the integrity, authenticity and verifiability of the data content via the Merkle DAG. On the other hand, the data content is stored in the at least one claim object, and a provider of the data content may have options to disclose all or part of the claim object. The provider of the data content can ensure the privacy via selective disclosure. Therefore, the computer-implemented method and system for storing verifiable data of the present inventive concept can take into account the privacy, integrity, authenticity and verifiability.

The foregoing descriptions of the detailed embodiments are only illustrated to disclose the features and functions of the present inventive concept and not restrictive of the scope of the present inventive concept. It should be understood to those in the art that all modifications and variations according to the spirit and principle in the disclosure of the present inventive concept should fall within the scope of the appended claims.

What is claimed is:

1. A computer-implemented method for storing verifiable data, the method comprising:
generating a metadata object;
generating at least one claim object;
generating a proof object;
generating multiple identifiers, wherein each of the identifiers corresponds to the metadata object, the at least one claim object and the proof object, respectively; and
generating a Merkle DAG based on the multiple identifiers, the metadata object, the at least one claim object, and the proof object, wherein the Merkle DAG is constructed by nodes which are created based on the multiple identifiers.

2. The computer-implemented method for storing verifiable data of claim 1, the method further comprises:
transmitting the metadata object, the at least one claim object and the proof object to a first storage system, and storing the metadata object, the at least one claim object and the proof object via the first storage system.

3. The computer-implemented method for storing verifiable data of claim 2, wherein the first storage system is a storage system having authority control over the objects.

4. The computer-implemented method for storing verifiable data of claim 1, the method further comprises:
transmitting the Merkle DAG to a second storage system, and storing the Merkle DAG via the second storage system.

5. The computer-implemented method for storing verifiable data of claim 4, wherein the second storage system is a Ledger database.

6. The computer-implemented method for storing verifiable data of claim 1, wherein each of the multiple identifiers has hash information, respectively.

7. A system for storing verifiable data, the system comprising:
a processor; and
a computer-readable medium storing program instructions that when executed by the processor cause the processor to:
generate a metadata object;
generate at least one claim object;
generate a proof object;
generate multiple identifiers, wherein each of the identifier corresponds to the metadata object, the at least one claim object and the proof object, respectively; and
generate a Merkle DAG based on the multiple identifiers, the metadata object, the at least one claim object, and the proof object, wherein the Merkle DAG is constructed by nodes which are created based on the multiple identifiers.

8. The system for storing verifiable data of claim 7, wherein the program instructions are executed by the processor to:
transmit the metadata object, the at least one claim object and the proof object to a first storage system, and store the metadata object, the at least one claim object and the proof object via the first storage system.

9. The system for storing verifiable data of claim 8, wherein the first storage system is a storage system having an authority control over the objects.

10. The system for storing verifiable data of claim 7, wherein the program instructions are executed by the processor to:
transmit the Merkle DAG to a second storage system, and store the Merkle DAG via the second storage system.

11. The system for storing verifiable data of claim 10, wherein the second storage system is a Ledger database.

12. The system for storing verifiable data of claim 7, wherein each of the multiple identifiers has hash information, respectively.
